(19) United States
(12) Patent Application Publication
(10) Pub. No.: US 2011/0263353 A1
(43) Pub. Date: Oct. 27, 2011

(54) GOLF TEE AND IMPROVED MANUFACTURING METHOD FOR SAME

(76) Inventor: DAVID BROSTROM, SPENCER, IA (US)

(21) Appl. No.: 13/092,196

(22) Filed: Apr. 22, 2011

Related U.S. Application Data
(60) Provisional application No. 61/326,866, filed on Apr. 22, 2010.

(51) Int. Cl. A63B 57/00; B29C 47/00

(52) U.S. Cl. 473/399; 264/319

(57) ABSTRACT

Golf tees are prepared from dowel blanks that are a composite material, rather than 100% wood, with the composite preferably being biodegradable, so it will weather away.

### CROSS-REFERENCE TO RELATED APPLICATIONS

This application claims priority under 35 U.S.C. §119 to provisional application Ser. No. 61/326,866 filed Apr. 22, 2010, herein incorporated by reference in its entirety.

### BACKGROUND OF THE INVENTION

The present invention relates generally to the game of golf and pertains, more specifically, to a golf tee and a method for making the golf tee.

The game of golf has enjoyed ever-increasing popularity, and golf-related items and equipment continually are being developed in an effort to assist more and more players in improving their game. The golf tee is a basic piece of equipment utilized by all players and has been offered over the years in a myriad of constructions and configurations. However, the most prevalent golf tee currently in use is in the form of a simple wooden or bamboo tee which is easily used and inexpensive enough to be expendable. Attempts at replacing the ubiquitous wooden golf tee with paper or plastic tees in various configurations have met with little success, primarily due to a lack of improved performance or unwarranted increased expense.

Golf tees heretofore used are formed by cutting and shaving wood members or by molding utilizing a synthetic resin or the like.

With golf tees formed by cutting and shaving wood, however, cutting wastes and shavings resulting from the manufacturing process translates to a loss of resources. Even worse, the manufacture of golf tees by this method is troublesome.

The use of golf tees made by molding a synthetic resin or the like causes a pollution of the environment because many of the tees are broken and scattered in and around the tee area; and, since they neither weather nor decay, they become a disposal problem.

A primary object of the present invention is to provide a golf tee which can be easily manufactured without waste and which does not spoil the environment of a golf course, and which uses less wood.

Another object of the present invention is to provide a manufacturing method for a novel golf tee that extrudes tees from a composite material, or that lathes tees from an extruded composite dowel.

A further invention relates to a golf tee formed of a material which is biodegradable or recycled material.

A further embodiment of the present invention relates to a method of manufacturing a golf tee comprising a process of preparing a composite material, molding a tee made of the aforementioned substance and a drying and hardening the molded tee by heating. The resulting golf tee weathers away when it is left in the ground.

The above-mentioned objects, features and advantages of the present invention will become more apparent from the detailed description of the embodiments discussed below.

### BRIEF SUMMARY OF THE INVENTION

This invention relates to an improved manufacturing process for making golf tees by producing dowels of wood composite material, which may be lathed into golf tees. The composite could be for example of wood sawdust, wood flour, corn stalks, fiberous materials such as cotton, other cellulosic biodegradable materials, preferably 70% waste cellulosic material that is biodegradable, and 30% wood based material, such as wood sawdust. The composite material is extruded into dowels at the same diameter as finished tees, and then lathed into a tee. Alternatively, extruded composite can be mold shaped directly into a tee. As a result, less wood is used, the composite material dowel is more easily manufactured, and because of the biodegradable materials used, a biodegradable tee results such that the waste eventually weathers away, and any wood shavings can be recycled.

### DETAILED DESCRIPTION OF THE PREFERRED EMBODIMENTS

Golf tees are typically made by the following rather lengthy and expensive process. First logs are of course harvested. The harvested logs are then transported back to a lumber treatment factory where they are debarked and sawed into slats. The slats are then kiln dried. Next in conventional tee making the slats are mechanically turned into dowels. The dowels are lathed into golf tees. Rough tees are then put through a vibrating process to shake out irregular shapes, dowel ends, and other errors in the manufacturing process. The vibration technique actually acts as a rubbing and sanding process for the tees which are then painted, packaged and ready for sale.

There are a number of labor-intensive and expensive steps in this process. Especially the wooden dowel making It is not only expensive but it also consumes the maximum amount of lumber since the dowels are 100% lumber. In accordance with the process of the present invention, dowels are extruded from a composite material of for example wood sawdust, wood flour, corn stalks, other cellulosic by-product materials and some starch degradable polymers in one preferred method. A degradable material most likely would be derived from corn, soybeans or wheat since much biodegradable cellulose is available from the ordinary process of growing crops of corn, soybeans or wheat.

The amount of composite can vary from 30% wood dust material to 70% wood dust material, the balance being the biodegradable material. The presently preferred formula is 70/30, with 70% sawdust.

The combined composite recipe is fully mixed and then heat extruded into dowels that have the same diameter as conventional finished golf tees. Color or other additives may be added if desired to the dowels or tees prior to extrusion. The extruded materials are then air or water quenched. Afterwards the dowels are lathed in a manner similar or identical to the method currently used to produce 100% wooden tees.

In an alternative forming process the tees are molded or tamped or extruded from the doughy composite material and air dried. Certain observations are worthy or note. For example if the tees are lathed, no polishing or sanding steps are needed as the lathing seems to put the best finish polish on the tee, with sanding actually decreasing the luster of the tee. Thus only lathing is required.

Due to humidity it is preferred that wood flour or sawdust is derived from lumber mills that use kiln dried wood. It appears to make no difference whether soft woods or hard woods are used in terms of affecting the strength of the composite tee.

Another extreme advantage of the product of the present invention is that there is no dowel waste. Waste material is simply recycled into the next go-around.

Work with the precise composite recipe for extruding to achieve the right good physical characteristics makes tapered extrusion possible. These tees have an advantage from strength possibly because the extruding, pulling and stretching aligns the molecules. One reason that extruded tapered tees might be preferred instead of lathed tees is the ability to be taper extruded.

The present technology has been developed primarily with the idea in mind of making improved golf tees and of increasing efficiency in the manufacturing process. It should be apparent that it can be used for other normal wooden products as a replacement manufacturing process in making a pencil. Normally pencils are milled from slats; here the slats can be made from the composite. Other uses should come to mind to one of ordinary skill in the art of the base composite material.

As described the invention as it relates to the embodiment referenced in the detailed description of a preferred embodiment, it goes without saying that the present invention is not limited to the details of the description but rather should be construed broadly within the spirit and scope set out in the accompanying claims.

What is claimed is:

1. An improvement in the golf tee manufacturing process, comprising:
preparing blank dowels from which golf tees are derived from a composite material that is from 30% to about 70% of sawdust with the balance being biodegradable waste material.

2. The process of claim 1 wherein the dowel blank is about 30% sawdust and 70% waste material.

3. The process of preparing golf tees from an extrudate of composite material, molded into golf tees, the composite material comprising about 30% to about 70% of sawdust, with the balance being biodegradable waste material.

4. The process of claim 3 wherein the composite is about 30% waste material and 70% sawdust.

5. The process of claim 1 wherein the biodegradable waste material is selected from the group consisting of cellulosic waste of corn, soybeans and wheat.

6. The golf tee produced by the process of claim 1.

7. The golf tee produced by the process of claim 3.
